(19) United States
(12) Patent Application Publication
(10) Pub. No.: US 2026/0364724 A1
(43) Pub. Date: Nov. 19, 2026

(54) COMBINATION CUTOFF AND PREPARATION TOOL AND METHODS OF USING SAME

(71) Applicant: Scott Barton, Clifton Park, NY (US)

(72) Inventor: Scott Barton, Clifton Park, NY (US)

(21) Appl. No.: 19/207,517

(22) Filed: May 14, 2025

(51) Int. Cl. B23P 23/04

(52) U.S. Cl. CPC B23P 23/04

(57) ABSTRACT

Devices and methods are disclosed for the simultaneous cutting and sanding of construction materials, eliminating additional material handling, reducing the risk of damage, and minimizing setup operations. These innovations prepare materials for finishing or assembly with greater efficiency, requiring fewer steps, less time, and reduced costs. Designed to cut and sand construction materials flush with the surface of another material in its current, future, or final assembled state, these devices are versatile and adaptable for various applications. They are compatible with a wide range of construction materials, offering a precise and streamlined solution for efficient surface preparation.

### FIELD OF THE INVENTION

The present invention relates to devices and methods for the use with construction materials and more specifically to devices and methods for use in the shaping and preparation of construction materials used in construction, manufacturing or renovation.

### BACKGROUND

Filling, repairing, and restoring through-holes, cracks, dents, and other localized defects during the manufacture, installation, or renovation of industrial, commercial, and residential construction materials is problematic. Preparing, sizing, fitting, cutting, sanding, finishing and restoring damaged construction materials cosmetically and structurally requires knowledge, experience, and skilled individuals additional time and cost and can still leave visible defects if not done correctly. Devices and materials for use in this type of construction are detailed in U.S. patent application Ser. No. 18/824,075 incorporated herein by reference.

When repairing, manufacturing+ or constructing surfaces in existing or new construction materials, the material may be repaired or constructed using straight or conical repair devices, like that described in U.S. patent application Ser. No. 18/824,075. Once these cutoff and preparation devices are placed into a construction material to be repaired, they may extend beyond the outer surface of the construction material to be repaired. It is therefore necessary to cut these devices flush or nearly flush to the outer surface of the construction material to be repaired. After cutting it is also necessary to prepare these devices for eventual painting by sanding, planing or chiseling the outer surface or utilizing other preparation methods known in the art. Existing tools exist to complete each of the cutoff and preparation tasks separately. For instance, grinders, hand saws or powered cutoff saws are capable of removing the portion of the cutoff and preparation device that extends beyond the outer surface of the construction material under repair and disc sanders, hand sanders planes, rasps and chisels exist that are capable of preparing the surface of the cutoff and preparation device after the outer portion has been cut off. Although these separate steps do complete the overall process of removing excess material and preparing the surface of the cutoff and preparation device for plastering, painting or other finishing processes known in the art, the fact that they must be done independent of one another leads to potential issues.

For instance, the initial cutoff may leave an uneven surface that may cause the preparation tool to have difficulty in successfully creating a level surface or may actually cause the preparation tool to damage surfaces of the construction material under repair around the cutoff and preparation device. Therefore, there exists a need for a tool that can accomplish both the removal of the portion of the cutoff and preparation device that extends outside the construction material under repair and prepares the remaining surfaces for final repair.

Additionally, the use of multiple tools requires the user to take additional time in their work to swap these tools in an out, depending on whether the user is cutting off the cutoff and preparation device or preparing the cutoff and preparation device for final construction. This tool swapping also increases the likelihood of a tool not being properly installed and therefore creating issues with proper use.

Therefore, there exists a long-felt need for a combination cutoff and preparation tool that can accomplish both the removal of the portion of the cutoff and preparation device that extends outside the construction material under repair and prepares the remaining surfaces for final repair.

### SUMMARY

In a first embodiment of the combination cutoff and preparation tool a flat saw toothed blade is attached to the distal end of the base of a holder on the proximal end of the flat saw toothed blade. Attached to the base of the holder is an abrasive material such that a user may place the blade and holder assembly against a flat surface and move the assembly in a motion parallel to the longitudinal axis of the flat saw toothed blade, allowing the blade to cut through a material extending perpendicularly to the flat surface and further allowing the user to them move the holder of the assembly over the newly cut surface and using the abrasive material, level it with the remainder of the flat surface.

In a first aspect of the first embodiment of the combination cutoff and preparation device, the holder includes flat extensions from each side of the holder, the bottom of which are level with the abrasive material, providing lateral stability to the assembly and ensuring that the cut in the material extending from the flat surface maintains the same distance from the flat surface across the entire material and further ensuring that the abrasive material levels the material extending from the flat surface even with the flat surface surrounding the material.

In a second embodiment of a combination cutoff and preparation device an oscillating blade attached to an oscillating multi-tool includes a cutting surface and an abrasive surface offset from the cutting surface, wherein when the abrasive surface of the blade is placed against a flat surface and the tool advanced along the longitudinal axis of the multi-tool, the cutting surface is able to cut through a material extending perpendicularly from the flat surface and the abrasive material is able to level the material extending perpendicular to the flat surface with the flat surface.

In a first aspect of the second embodiment, the oscillating blade includes flat extensions from each side of the blade, proximal to the cutting surface, the bottom of which are level with the abrasive material, providing lateral stability to the assembly and ensuring that the cut in the material extending from the flat surface maintains the same distance from the flat surface across the entire material and further ensuring that the abrasive material levels the material extending from the flat surface even with the flat surface surrounding the material.

In a third embodiment of a combination cutoff and preparation device a modified circular saw blade includes a cutting surface and an abrasive surface offset from the cutting surface and is attached to a motorized cutoff or grinder tool, wherein when the abrasive surface of the modified circular saw blade is placed against a flat surface and the motorized tool advanced along the longitudinal axis of the motorized tool, the cutting surface is able to cut through a material extending perpendicularly from the flat surface and the abrasive material is able to level the material extending perpendicular to the flat surface with the flat surface

In a first aspect of the third embodiment, the modified circular saw blade includes flat portions inset towards the rotational axis between the cutting surface and the abrasive surface and optionally flat portions inset towards the rotational axis between the abrasive surface and the axis of rotation.

In a fourth embodiment of a combination cutout and preparation device a circular hole cutting saw includes a cutting surface at the distal end of the saw and an abrasive surface spaced proximally from the distal cutting surface and with a diameter larger than the diameter of the cutting surface such that when e device is attached to a drill and advanced into a material, the material has a circular hole cut into it and further advancement of the device causes the abrasive surface slightly increase the diameter of the cut hole and to smooth finish the inside surface of the hole.

In a first aspect of the fourth embodiment the device further includes a beveled surface extending from the outer diameter of the cutting surface to the outer diameter of the abrasive surface, ensuring that as the tool is advanced beyond the cutting portion that it remains centered in the hole that has been cut.

In a second aspect of any of the above embodiments, the abrasive material is one of a diamond coating, an abrasive metal coating or an epoxy adhered silica coating permanently bonded to the device.

In a third aspect of any of the above embodiments the abrasive material is bonded to a metal backing, wherein the metal backing is disposed to be removably connected to the cutoff and preparation device.

In another aspect of the third aspect above, the metal backing further includes an adhesive backing on the side of the metal backing opposite the abrasive material for affixing the metal backing to the device.

In a first embodiment of a method of using the cutoff and preparation device of any of the first three described embodiments, a user places the device against a flat surface, the flat surface including a material that extends above the flat surface. The user then advances the device against the material extending above the flat surface to cut off the material. The user then further advances the device such that the abrasive surface removes more of the material extending above the flat surface, preparing the surface for painting, or other finishing.

The above-noted features and advantages of the present invention, as well as additional features and advantages, will be readily apparent to those skilled in the art upon reference to the following detailed description, accompanying drawings and appended claims, which include a disclosure of the best mode of making and using the invention presently contemplated.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 is an isometric view of a cutoff and preparation device, according to a first embodiment of the present disclosure with a flat blade and holder whereby the blade is attached to the holder through a linear assembly.

FIG. 1A is a cross sectional view of FIG. 1, according to a first embodiment of the present disclosure with a flat blade and holder.

FIG. 2 is an isometric view of the cutoff and preparation device according to a first embodiment whereby the blade is attached to the holder through a rotational assembly.

FIG. 3 is an isometric view of a cutoff and preparation device of FIG. 2, showing the abrasive surface location on the blade.

FIG. 4 is an isometric view of a cutoff and preparation device of FIG. 2, showing the abrasive surface location on the holder.

FIG. 5 is an isometric view of a cutoff and preparation device of FIG. 2, showing a recessed blade surface which accepts replaceable adhesive surfaces.

FIG. 6 is an isometric view of a cutoff and preparation device according to a first embodiment of whereby the blade is rotationally attached to the holder and can be rotated during use.

FIG. 7 is a cross sectional view of a cutoff and preparation device according to a first embodiment, including a set of stabilizing tabs on both sides of the holder.

FIG. 8 is an isometric view of a cutoff and preparation device, according to a second embodiment of the present disclosure, utilizing a multi-tool configuration.

FIG. 9 is an isometric view of a cutoff and preparation device, according to a second embodiment of the present disclosure, utilizing a multi-tool configuration and including stabilizing tabs on both sides of the multi-tool blade.

FIG. 10 is an isometric view of a cutoff and preparation device, according to a third embodiment of the present disclosure, utilizing a circular saw configuration.

FIG. 11 is an isometric view of a cutoff and preparation device, according to a third embodiment of the present disclosure, utilizing a circular saw configuration, including stabilizing tabs on both sides of the circular saw.

FIG. 12 is an isometric view of a hole preparation device, according to a fourth embodiment of the present disclosure with an abrasive surface on the sides of the blade.

FIG. 13 is an isometric view of a hole preparation device blade of FIG. 12, with an abrasive surface on the sides of the blade and a proximal stepped abrasive surface.

### DETAILED DESCRIPTION

The present disclosure relates generally to a device for working with materials used in construction and more specifically relates to a device used to cut off and prepare a material used in the repair of a construction surface.

It will be recognized that the scope of the present disclosure is not limited by specific applications, and that the apparatus and methods described herein may be employed in a variety of implementations. Further, while the ensuing disclosure includes illustrative embodiments employing devices and methods for the repair of construction materials, it will be appreciated that the disclosure contemplates the use of the device and methods on other materials where the use of the device provides a repair function.

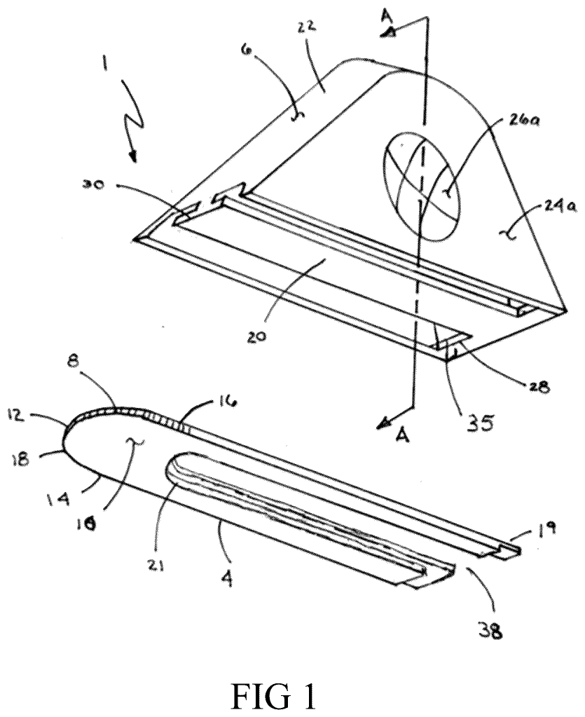

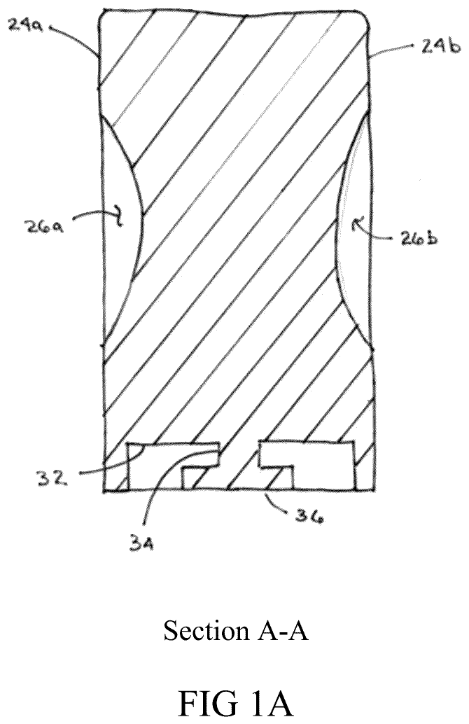

Referring to FIG. 1 and FIG. 1A, a cutoff and preparation device 1 is shown. Cutoff and preparation device 1 comprises a flat blade 4 and a holder 6. Flat blade 4 comprises a top flat surface 8, a bottom flat blade surface 10, a distal edge 12, a right edge 14, a left edge 16, a proximal step 19 and a middle stepped slot 21. One of right edge 14 and left edge 16 further comprises a cutting surface 18. Cutting surface 18 may be knife-like cutting surface, a saw-like cutting surface, an abrasive cutting surface or other cutting surface known in the art. In an alternative embodiment, both right edge 14 and left edge 16 comprise a cutting surface 18. Distal edge 12 may be curved or straight and may also comprise a cutting surface 18. Holder 6 may comprise a bottom flat holder portion 20, a top portion 22 side portions 24a and 24b and indentations 26a and 26b which may be located on the side portions 24a and 24b respectively. Holder 6 may further comprise a proximal blade holding portion 28, a distal blade holding portion 30 and a bottom recessed surface 32. Both proximal blade holding portion 28 and distal blade holding portion 30 extend perpendicularly to bottom recessed surface 32. Proximal blade holding portion includes a lip 35 that interacts with proximal step 19 to hold the proximal portion of flat blade 4. Distal blade holding portion 30 comprises a post portion 34 and a top portion 36. The proximal portion of stepped slot 21 includes a gap 38, larger than the top portion 36. The smaller portion of middle stepped slot 21 is larger than post portion 34 but smaller than top portion 36. The larger portion of middle stepped slot 21 is larger than top portion 36. When attaching flat blade 4 to holder 6 the user places the distal blade holding portion 30 into gap 38 and then moves the flat blade 4 proximally until the proximal step 19 engages the proximal blade holding portion 28.

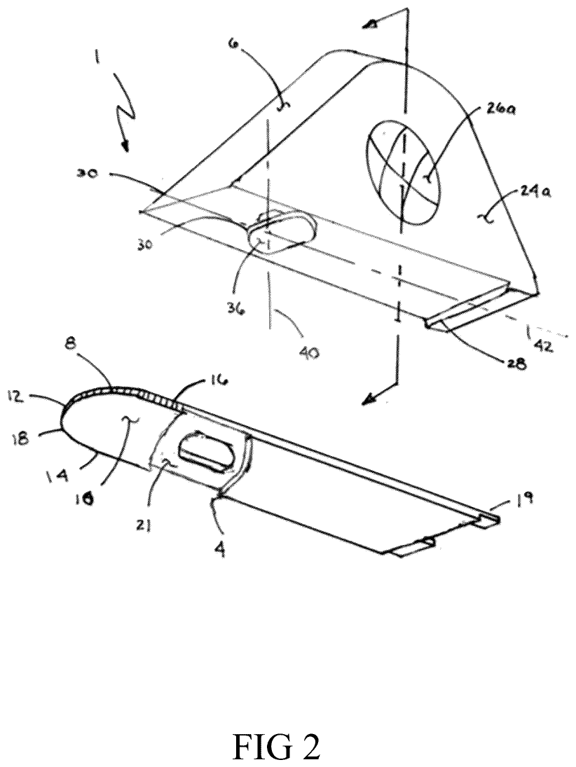

In an alternative embodiment, shown in FIG. 2, the top portion 36 of distal blade holding portion 30 comprises an elongated post disposed with the axis 40 of the elongated post perpendicular to the longitudinal axis 42 of the holder 6. To attach the flat blade 4 to the holder 6, the user places the middle stepped slot 21 over the top portion 36 such that the two align and then rotates the flat blade 4 by 90 degrees such that slot axis 44 of middle stepped slot aligns with the longitudinal axis 42 of the holder 6 and the proximal step 19 is under the proximal blade holding portion 28.

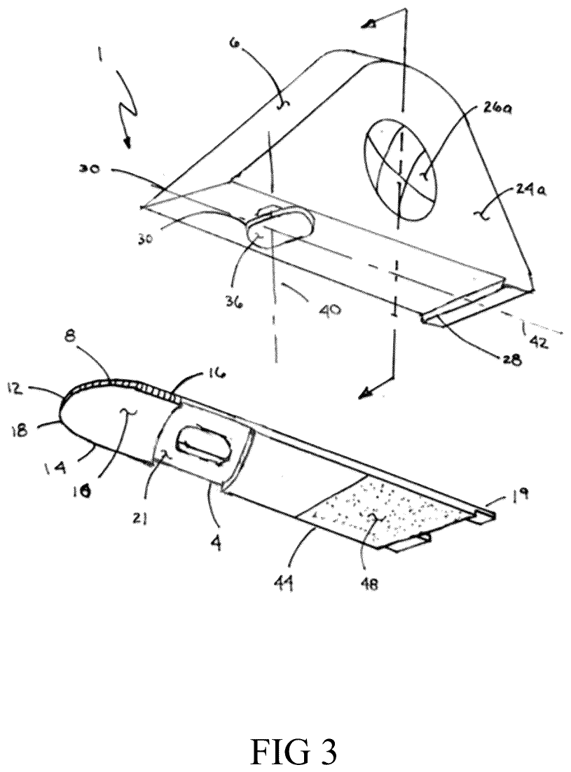

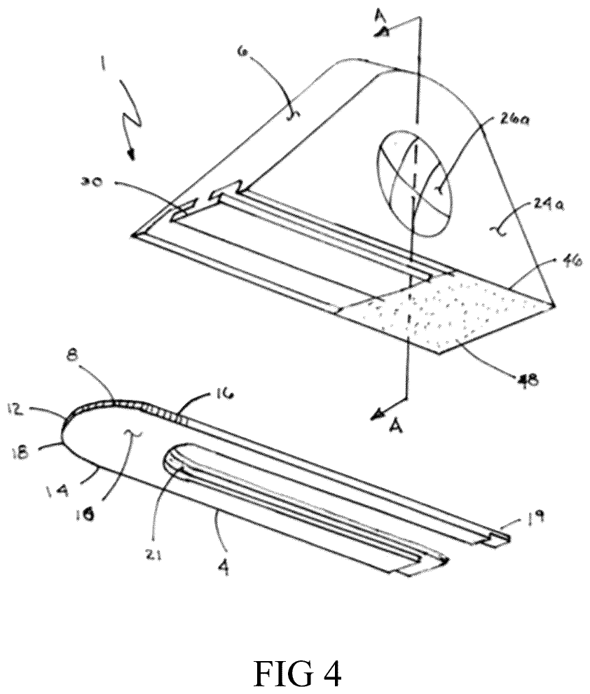

Referring to FIG. 3 and FIG. 4, either the entirety of the bottom flat blade surface 10 of flat blade 4 or the proximal portion 44 of bottom flat blade surface 10 of flat blade 4 or the proximal portion 46 of the holder 6 further comprises an abrasive surface 48. The abrasive surface 48 may be a rasp like texture or a sandpaper like texture with an abrasive material. The abrasive material may be comprised of a silica or metallic coating bonded to either the flat blade 4 or the holder 6. Alternatively, both the bottom flat blade surface 10 and the proximal portion 46 of the holder 6 may both have an abrasive surface 48.

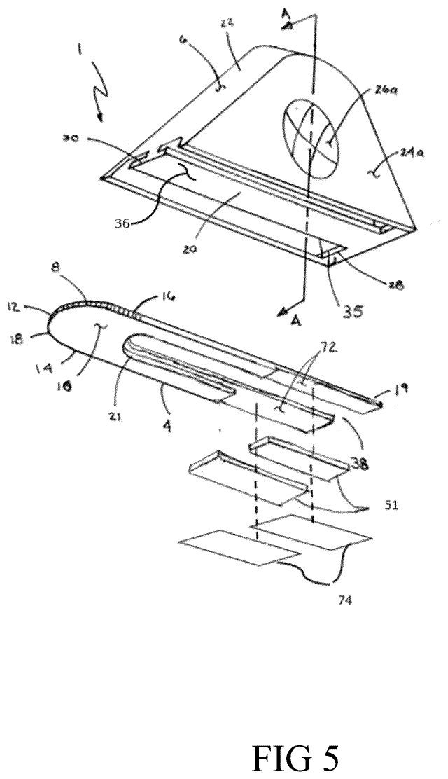

In an alternative embodiment of FIG. 1 shown in FIG. 5, the bottom flat holder surface 36 of the holder 6 or the bottom flat blade surface 10 of the flat blade 4 has a recess 72 that accepts an abrasive strip 74 with an adhesive backing 49 such that the abrasive surface 48 can be replaced as needed. This adhesive backing 49 may be applied directly to the back of the abrasive surface 48 or may be a separate layer of and adhesive tape 51 such as double sided 3M™ VHP™ adhesive tape, manufactured by 3M Industrial Adhesives and Tapes Division, St. Paul, MN. Alternatively, the bottom flat holder surface 36 of holder 6 may extend across the entirety of holder 6 and adhesive tape 51 may be used to attach flat blade 4 to holder 6.

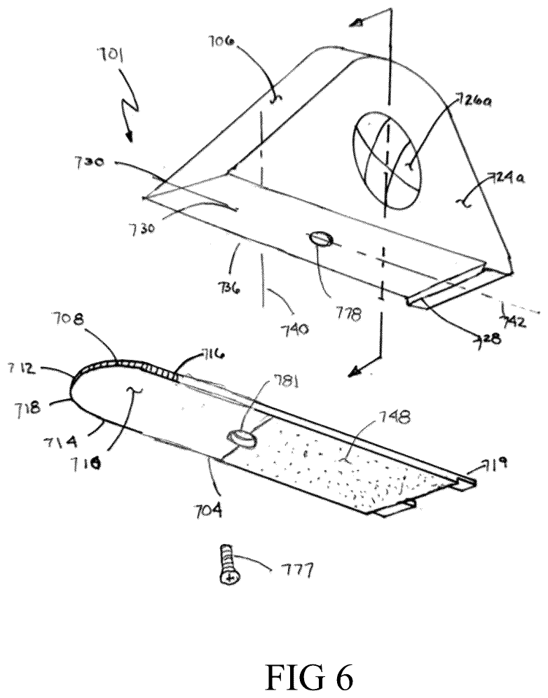

In yet another embodiment, shown in FIG. 6, flat blade 704 is rotationally attached to the holder 706 at the midpoint of flat blade 704 by a connector 777, the top of which sits flush with the bottom flat blade surface 710 of flat blade 704. Flat blade 704 may further comprise a countersunk hole 781. Holder 706 may further comprise a screw hole 778 that accepts connector 777. Connector 777 may be a countersunk screw, a countersunk rivet or any other connector known in the art that permits rotational movement around it. Half of the bottom flat blade surface 710 of flat blade 704 further comprises an abrasive surface 748 while at least one of the right edge 714 and the left edge 716 is disposed on the other half of the flat blade 704. The user rotates the flat blade 704 such that the abrasive surface 748 is under the holder 706 and then uses the left edge 716 and/or the right edge 714 of the flat blade to cut a construction item (not shown), such as a dowel or other object that projects above a planar construction surface (not shown). Once the construction item is cut, the user rotates the flat blade 704 about the connector 777 such that the cutting surface 718 is below the holder 706 and the abrasive surface 748 extends beyond the holder 706 so that it may be used to finish the construction item after it has been cut.

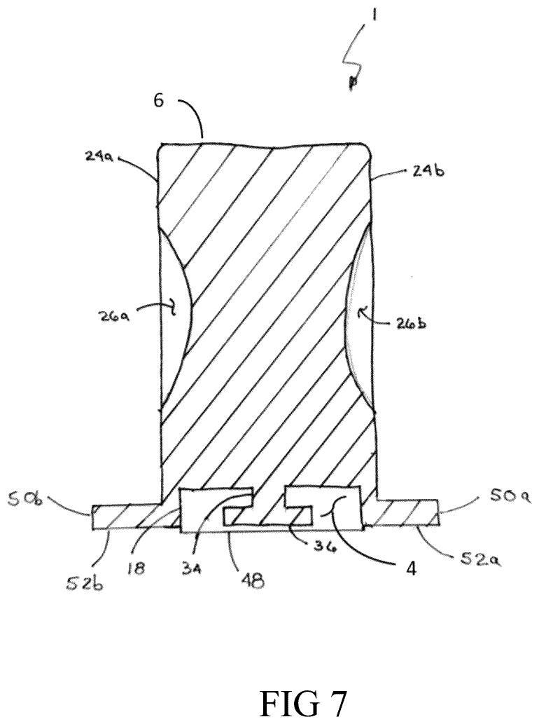

Referring now to FIG. 7, holder 6 further comprises a set of flat surfaces 50a and 50b that extend from the side portions 24a and 24b of holder 6. The bottom surfaces 52a and 52b are disposed such that abrasive surface 48 is slightly lower than flat surfaces 50a and 50b. Flat surfaces 50a and 50b provide stability to the device such that they keep the flat blade 4 and the holder 6 substantially parallel to any surface they are placed upon. As the combination cutoff and preparation device 1 is used, the user places the cutting surface 18 against a protrusion (not shown) that is to be cut. Moving the cutting surface back and forth against the protrusion cuts through and removes the protrusion from the flat surface that is being repaired. The user then advances the holder such that the abrasive surface 48 is moved over the remnants of the protrusion and the remnants of the protrusion are sanded or prepared for further finishing. Alternatively, the abrasive surface 48 may extend over the entire flat blade 4 such that cutting and sanding occurs at the same time.

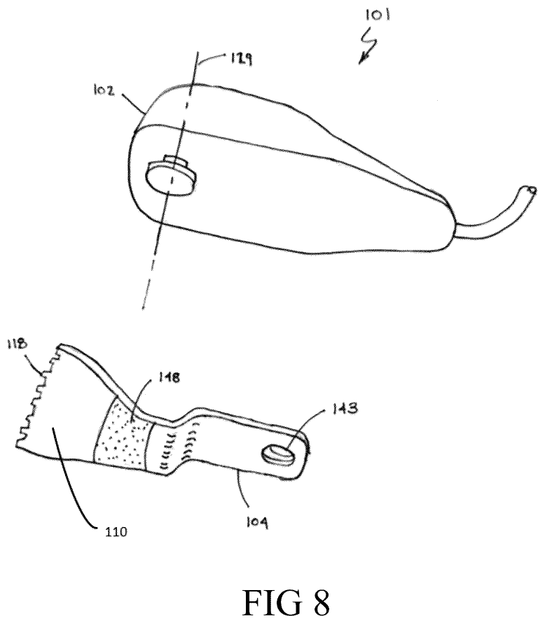

Referring now to FIG. 8, where similar numbers are used to denote similar features in FIG. 1, a combination cutoff and preparation device 101 is shown. Combination cutoff and preparation device 101 comprises an oscillating multi-tool 102 and an oscillating blade 104. Oscillating blade 104 comprises an offset cutting surface 118, an abrasive surface 148 and a multi-tool connection portion 143. The oscillating multi-tool 102 is of a standard configuration like those used in construction. An example of an oscillating multi-tool 102 is the Bosch Starlock Plus GOP18V-28, manufactured by Bosch Corp., Gerlingen, Germany. The offset cutting surface 118 of the oscillating blade 104 is disposed such that the cutting surface 118 may be placed and moved parallel to a flat construction surface without having the oscillating multi-tool interfere with the movement and cutting on the flat construction surface. The abrasive surface 148 is disposed such that it is proximal to the cutting surface 118 and is formed in an arc that matches its distance from the center of the rotation axis 119 of the multi-tool. In this way, the combination cutoff and preparation device 101 is brought into contact with a construction surface with a protruding portion that requires removal. The cutting surface 118 is brought into contact with the protrusion and cuts it off nearly flush with the remainder of the construction surface. The oscillating blade 104 is then advanced forward until the abrasive surface 148 interacts with the remnants of the protrusion and leaves the protrusion level with the remainder of the construction surface and prepared for additional processes such as painting. Alternatively, the abrasive surface 148 may extend over the entirety of the bottom flat blade surface 110 of the oscillating blade 104 such that cutting and sanding occurs at the same time.

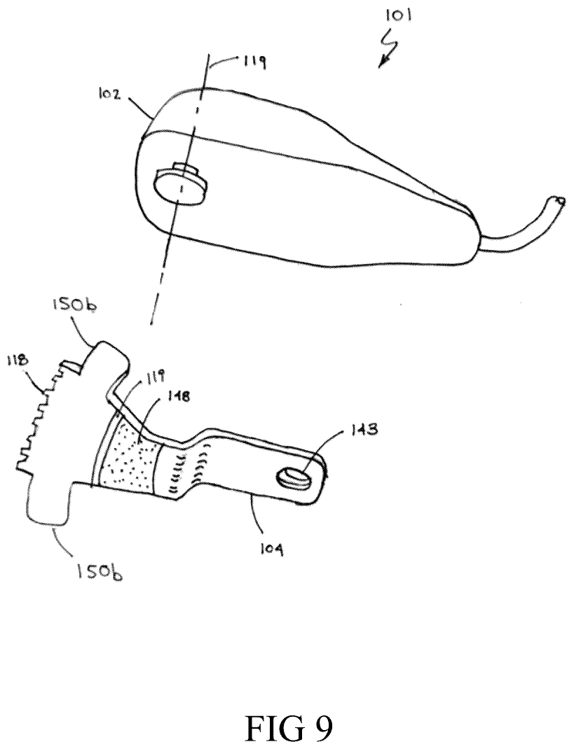

Referring now to FIG. 9, the oscillating blade 104 further comprises flat surfaces 150a and 150b. Flat surfaces 150a and 150b are disposed such that they interact with the flat construction material being repaired and such that the cutting surface 118 is raised slightly above the flat surface of the construction material to be repaired and such that the abrasive surface 148 is offset the same amount from the cutting surface 118 as are the flat surfaces 150a and 150b or extends slightly above flat surfaces 150a and 150b. Flat surfaces 150a and 150b are located to the sides of the oscillating blade 104 just proximal to cutting surface 118. In an alternative embodiment, the portion of the abrasive surface 148 closest to the cutting surface 118 is disposed such that it is not offset from the cutting surface 118 but progressively is offset from the cutting surface 118 as one moves along the abrasive surface 148 further from the cutting surface 118, forming a ramped surface 119. In yet another embodiment, the abrasive surface has the ramped surface 119 previously described in the more distal portion of the abrasive surface 148 but then has a flat (non-ramped) portion more proximal to the cutting surface 118. In another embodiment, the abrasive surface 148 may be comprised of an abrasive material applied to an adhesive backed metal portion (not shown) such that the abrasive surface 148 may be removed and replaced from the oscillating blade 104.

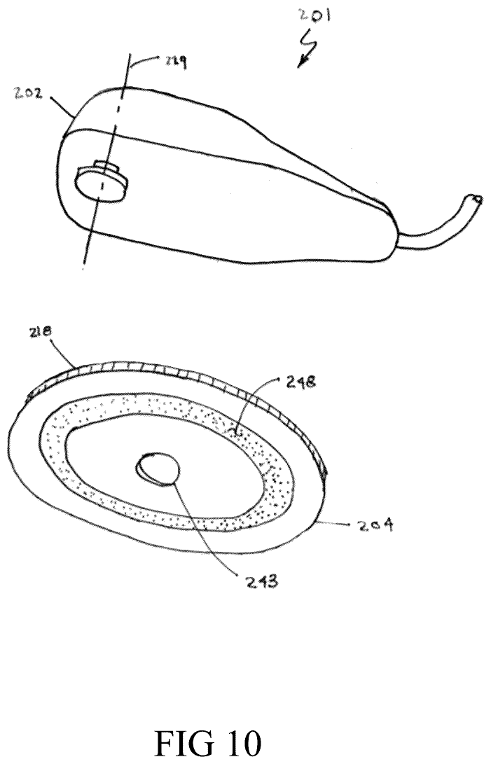

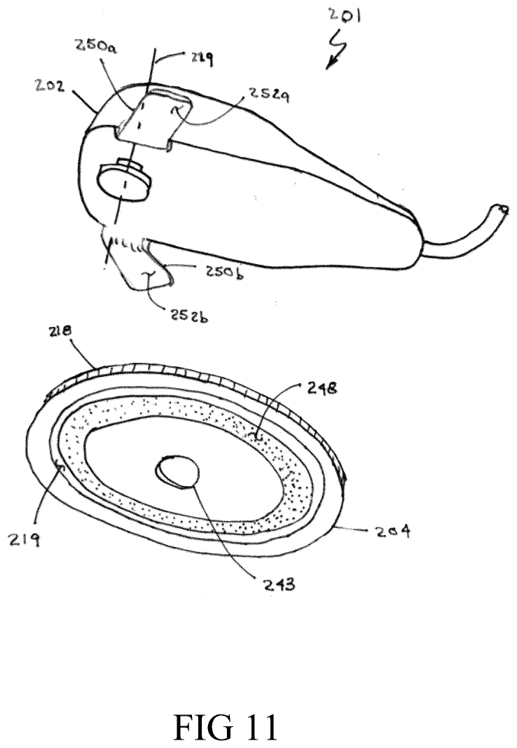

Referring now to FIG. 10, where similar numbers are used to denote similar features in FIG. 1, a combination cutoff and preparation device 201 is shown. Combination cutoff and preparation device 201 comprises a circular rotating blade 204 and a circular drive member 202. Circular rotating blade 204 further comprises a cutting surface 218, an abrasive surface 248 and a circular drive member connecting portion 243. Circular drive member 202 may be a circular saw or a cutoff grinder, a drill or other circular drive member known in the art. An example of a cutoff grinder is the Milwaukee M18 Fuel Angle Grinder, manufactured by Milwaukee Electric Tool Corporation in Brookfield Wisconsin, USA. An example of a circular saw is the Milwaukee M18 Fuel Circular Saw manufactured by Milwaukee Electric Tool Corp. in Brookfield Wisconsin, USA. An example of a drill is the Model 2606-20 electric drill manufactured by Milwaukee Electric Tool Corp in Brookfield Wisconsin, USA. The cutting surface 218 of the circular rotting blade 204 is on the outer periphery of the circular rotating blade 204. More central to the cutting surface 218 is the abrasive surface 248. The drive connecting portion 243 of the circular rotating blade 204 is offset from the remainder of the circular rotating blade 204 such that when the circular rotating blade 204 is in contact with a flat construction surface to be modified, no portion of the circular drive member 202 can come in contact with the flat construction surface. When a flat or otherwise formed construction surface has a protrusion which requires removal, the cutting surface 218 of the rotating circular blade 204 is brought into contact with the protrusion. Cutting surface may be kerfed surface, like that of a circular saw blade or a sharp surface like a razor blade on the periphery of the entire rotating circular blade 204. If may also be an abrasive surface such that as the rotating circular blade 204 rotates at high speed the cutting surface 218 abrades it way though the protrusion. In the case where the cutting surface 218 is an abrasive, the abrasive surface 248 may then be an extension on the base of the rotating circular blade 204 extending back from the cutting surface 218. Once cutting surface 204 removes the protrusion form the construction surface, the user continues to advance the cutoff and preparation device 201 such that the abrasive surface 248 further prepares the protrusion for addition finishing such as painting. Similar to the oscillating blade 104 of FIG. 8 and FIG. 9, an alternative embodiment of the circular cutting blade 204 may include a ramped abrasive surface 219 (as shown in FIG. 11) extending from the cutting surface 218 to the abrasive surface 248. In another alternative embodiment, the abrasive surface 248 is formed from a circular strip of metal (not shown) with an adhesive backing, such that the circular strip may be removed and replaced from the circular rotating blade 204.

Referring now to FIG. 11, another embodiment of the cutoff and preparation device 201 of FIG. 10 is shown. The circular drive member 202 further comprises flat surfaces 250a and 250b beyond the outer edge of rotating circular blade 204. The flat surfaces 250a and 250b may be placed against a flat surface that has a protrusion that is being removed, to provide greater stability to the cutoff and preparation device 201. The lower surfaces 252a and 252b of flat surfaces 250a and 250b extend from the circular drive member 202 the same amount as does the abrasive surface 248, helping to line the abrasive surface 248 up with an area that is being prepared.

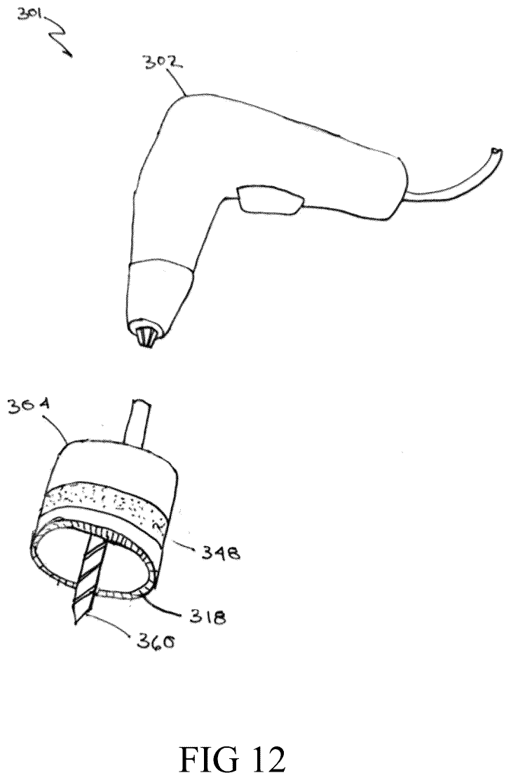

Referring now to FIG. 12, a hole cutout and preparation device 301 comprises a hole cutting blade 304 and a drill motor 302. Hole cutting blade 304 further comprises a cutting surface 318 and an abrasive surface 348. Hole cutting blade 304 may further comprise a guide drill 360. The abrasive surface 348 is of a slightly larger diameter than the cutting surface 318 such that once the cutting surface 318 passes through a surface that requires a hole, the abrasive surface 348 finishes the hole for further processing. In an alternative embodiment, the guide drill 360 is used to position the hole cutout and preparation device 301 at the correct position on a surface to be cut and functions to begin the cut prior to the cutting surface 318, laterally stabilizing the system such that the cutting surface 318 does not chatter and move across the surface being cut. Additionally, drill motor 302 may include an attachment (not shown) to ensure that the motion of the drill is kept perpendicular to the surface being cut. Such drill guides are known in the art.

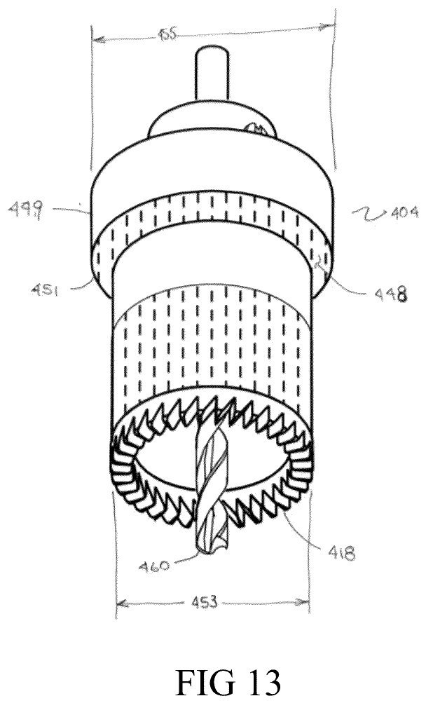

Referring now to FIG. 13, an alternative embodiment of the blade of a hole cutout and preparation device is shown. Hole cutting blade 404 further comprises a cutting surface 418 and an abrasive ring 449. Hole cutting blade 404 may further comprise a guide drill 460. The abrasive ring 449 comprises a planar ring 451 and an abrasive surface 448 such that once the cutting surface 418 passes through a surface that requires a hole (not shown), the abrasive surface 448 sands the surface requiring a hole for further processing. Alternatively, the area between the abrasive ring exterior diameter 455 and the blade exterior diameter 453 may include a chamfer (not shown) from the blade exterior diameter 453 to the abrasive ring exterior diameter 455. This chamfer may include an abrasive surface such that once the cutting surface 418 passes through a surface that requires a hole (not shown), the abrasive surface 448 sands the surface requiring a hole, creating a finished chamfer in the hole (not shown) for further processing.

While the disclosure has been described herein in reference to specific aspects, features and illustrative embodiments, it will be appreciated that the utility of the disclosure is not limited, but rather extends to and encompasses numerous other variations, modifications and alternative embodiments, as will suggest themselves to those of ordinary skill in the field of the present disclosure, based on the description. Correspondingly, the invention as claimed is intended to be broadly construed and interpreted as including all such variations, modifications and alternative embodiments, within its spirit and scope.

I/We claim:

1. A cutoff and preparation device for preparing a construction material, comprising;
a blade, comprising;
a cutting portion;
a connection portion;
a distal blade end;
a proximal blade end;
a top blade surface; and
a bottom blade surface;
a holder, comprising;
a connector;
a distal holder end;
a proximal holder end;
whereby at least a portion of at least one of said bottom blade surface and said proximal holder end further comprises an abrasive surface.

2. The cutoff and preparation device of claim 1, whereby said abrasive surface is selected from one of a sandpaper type abrasive or a rasp type abrasive surface.

3. The cutoff and preparation device of claim 1, whereby said connector comprises an adhesive tape and whereby said adhesive tape connects said blade to said holder.

4. The cutoff and preparation device of claim 2 whereby said connector of said holder further comprises;
a post; and
a post top; whereby said post top is disposed on a top of said post; and
whereby said blade is flat and further comprises;
a stepped slot, said stepped slot further comprising;
a small slot that extends from said top blade surface to said bottom blade surface;
a large slot that extends from said bottom blade surface a portion of the distance to said top blade surface.

5. The cutoff and preparation device of claim 4, whereby a width of said small slot of said stepped slot is larger than a width of said post and smaller than a width of said post top and whereby a width of said large slot of said stepped slot is larger than said width of said post top.

6. The cutoff and preparation device of claim 5, whereby said stepped slot is an elongated linear slot, further comprising;
a stepped slot length; and
whereby said post top further comprises;
a post top length.

7. The cutoff and preparation device of claim 6, whereby said stepped slot extends to said proximal blade end, forming an opening in said proximal blade end and whereby said stepped slot length is greater than or equal to said post top length and whereby said blade is connected to said holder by sliding said small slot of said stepped slot under said post top of said holder.

8. The cutoff and preparation device of claim 6, whereby said stepped slot extends from a point proximal to said distal blade end to a point distal to said proximal blade end by said stepped slot length and whereby said post top length is substantially equal to said stepped slot length and whereby said blade is attached to said holder by fitting said post top through said stepped slot and rotating said blade such that said post top sits on top of said small slot of said stepped slot.

9. The cutoff and preparation device of claim 2, whereby said connector of said holder further comprises;
a threaded hole; and
whereby said connection portion of said blade is disposed at the midpoint of said blade and further comprises;
a recessed hole;
whereby a screw placed through the connection portion and into said connector holds said blade to said holder and allows said blade to rotate around said screw such that different ends of said blade can be rotated to extend beyond said holder and whereby said screw sits withing said recessed hole such that said screw does not extend beyond said bottom blade surface.

10. The cutoff and preparation device of claim 9, whereby at least one of said proximal blade end further and said distal blade end comprises;
a step surface;
whereby said step surface is offset from said bottom surface of said blade, whereby the distance between said top blade surface and said bottom blade surface defines a blade thickness and whereby the distance between said bottom blade surface and said step surface defines a step thickness and whereby said step thickness is less than said blade thickness.

11. The cutoff and preparation device of claim 2, whereby said blade is a multi-tool blade and whereby said holder is an oscillating multi-tool, further comprising;
a motor; and
a casing;
whereby said multi-tool blade is connected to said holder with a fastener at said connector and whereby said cutting portion of said blade is offset from and parallel to said connection portion of said blade in a direction perpendicular to said connection portion of said blade.

12. The cutoff and preparation device of claim 11, whereby said cutting portion of said blade comprises a saw tooth surface comprising a plurality of saw teeth and whereby said saw teeth for an arc with a radius equal to a distance from said connection on said holder to said cutting portion and whereby said saw teeth are separated by a tooth distance and whereby said tooth distance is fixed and selected from a plurality of tooth distances matching a tooth distance for a material to be cut.

13. The cutoff and preparation device of claim 12, whereby said abrasive portion is disposed on a proximal portion of said cutting portion, said proximal portion of said cutting portion being disposed proximally to said plurality of said saw teeth.

14. The cutoff and preparation device of claim 2, whereby said blade is a circular saw type blade and whereby said holder is a circular saw, whereby said circular saw type blade is connected to said circular saw with a fastener at said connection portion of said blade and whereby said blade rotates about a rotation axis is said blade and whereby said cutting potion of said blade is offset from and parallel to said connection portion of said blade in a direction along said rotation axis.

15. The cutoff and preparation device of claim 14, whereby said cutting portion of said blade comprises a saw tooth surface comprising a plurality of saw teeth whereby said saw teeth are separated by a tooth distance and whereby said tooth distance is fixed and selected from a plurality of tooth distances matching a tooth distance for a material to be cut.

16. The cutoff and preparation device of claim 15, whereby said abrasive portion is disposed on said blade closer to said connector than said saw teeth.

17. The cutoff and preparation device of claim 1, whereby said blade is flat and further comprises;
a blade thickness;
a proximal stepped end, comprising;
a proximal stepped end thickness; and
a proximal stepped end length;
whereby said holder further comprises;
a proximal post, comprising;
a proximal post; and
a proximal post top height; and
a proximal post top, comprising;
a proximal post top thickness;
whereby said proximal post top is disposed on the top of said proximal post and whereby said proximal post top thickness is greater than said proximal post thickness and whereby said proximal post height is greater than said proximal stepped end thickness and whereby said proximal stepped end length is greater than the difference between said post thickness and said post top thickness and whereby when said blade is attached to said holder, said proximal post stops said blade from further motion and whereby said blade is held in said holder by said proximal post top.

18. A cutoff and preparation device for preparing a construction material, comprising;
a blade, further comprising;
a cutting portion;
a connection portion;
a distal blade end;
a proximal blade end;
a pilot drill portion;
a blade axis;
an abrasive portion and
a holder, comprising;
a connector; and
a handle;
whereby said blade is a thinned walled cylinder disposed around said blade axis, whereby said cutting portion is disposed on said distal blade end, whereby said abrasive portion is disposed on an outside diameter of said thin walled cylinder and whereby said holder is an electric drill.

19. The cutoff and preparation device of claim 18, whereby said blade further comprises;
a proximal cylinder;
a proximal cylinder diameter; and
a proximal cylinder step surface;
whereby said proximal cylinder is disposed on said proximal blade end and whereby said proximal cylinder diameter is of a diameter greater than said outside diameter of said thin walled cylinder and whereby the difference between said outside diameter of said thin walled cylinder and said proximal cylinder diameter forms said proximal cylinder step surface and whereby said proximal cylinder step surface is coated with an abrasive material.

20. The cutoff and preparation device of claim 19 whereby said proximal cylinder step surface is one of a surface disposed perpendicular to said blade axis or a surface disposed at an acute angle to said blade axis.
